(19) United States
(12) Patent Application Publication
(10) Pub. No.: US 2024/0242032 A1
(43) Pub. Date: Jul. 18, 2024

(54) SYSTEMS AND METHODS FOR UNSUPERVISED NAMED ENTITY RECOGNITION

(71) Applicant: Wells Fargo Bank, N.A., San Francisco, CA (US)

(72) Inventors: Yong Yi Bay, Normal, IL (US); Qianhui Rong, Charlotte, NC (US); Yang Angelina Yang, Mountain View, CA (US); Menglin Cao, Danville, CA (US)

(21) Appl. No.: 17/317,110

(22) Filed: May 11, 2021

Related U.S. Application Data
(63) Continuation of application No. 17/209,640, filed on Mar. 23, 2021, now abandoned.

(51) Int. Cl. G06F 40/295; G06K 9/62; G06N 3/08

(52) U.S. Cl. CPC G06F 40/295; G06K 9/6215; G06K 9/6223; G06K 9/6256; G06N 3/088

(57) ABSTRACT

Systems, apparatuses, methods, and computer program products are disclosed for unsupervised named entity recognition. An example method includes receiving, by a communications circuitry, a reference named entity list, the reference named entity list identifying a set of named entities and an entity type of each identified named entity. The example method further includes generating, by a vectorizer, vectors from the named entities identified in the reference named entity list, and consolidating, by a synthesizer, the generated vectors into a set of representative vectors, wherein each representative vector is associated with a particular entity type. Finally, the example method receiving, by an analysis engine, a set of text, and performing, by the analysis engine, named entity recognition on the set of text using the set of representative vectors to generate a tagged set of text.

### CROSS-REFERENCE TO RELATED APPLICATIONS

This application claims the benefit of U.S. patent application Ser. No. 17/209,640, filed Mar. 23, 2021, which is incorporated by reference herein in its entirety.

### TECHNOLOGICAL FIELD

Example embodiments of the invention relate generally to natural language processing and, more particularly, to systems and methods that perform unsupervised named entity recognition.

### BACKGROUND

Named entity recognition is the task of identifying and categorizing entities in a set of text. An “entity,” in this regard, may refer to an individual word, or a combinations of words, that consistently refer to the same thing. A named entity, in turn, is an entity that comprises a real-world object. For instance, given the string “Biden was born in Scranton and worked in the Senate,” each discrete word separated by white space in the string may comprise an entity (although entities may comprise multiple words depending on the implementation; if the string included the text “Joe Biden” instead of just “Biden,” some named entity recognition systems would identify “Joe Biden” as an entity, while others may identify “Joe” as an entity and “Biden” as a different entity). Moreover, the entities “Biden”, “Scranton” and “Senate” are named entities. A system that performs named entity recognition may receive the string “Biden was born in Scranton and worked in the Senate” and identify the various entities in the string, and may further categorize the named entities (e.g., “Biden” may be tagged with the entity type “person”, “Scranton” may be tagged with the entity type “location” and Senate” may be tagged with the entity type “organization”).

### BRIEF SUMMARY

Entire industries leverage computer technology in new ways thanks to improvements in the ability of computers to respond to human instruction. The sophistication of today's virtual assistants and smart speakers are based on improvements in recent years in natural language processing (i.e., the techniques by which computers can process and analyze natural language data). Because named entity recognition enables the identification of and categorization of named entities in natural language text, named entity recognition is a critical element of most natural language processing systems used today. Accordingly, enhancements in named entity recognition produce improvements in a wide array of downstream technologies.

The most accurate named entity recognition systems today are trained using supervised machine learning techniques. Although some of these systems are nearly as accurate as humans at performing named entity recognition tasks, such systems are genre-specific and task-dependent. Moreover, training such systems can be a painstaking task, because it requires a large amount of high quality annotated data, which is expensive to obtain (annotated data is generally created through countless hours of human effort to label the data). Thus, although supervised named entity recognition systems can be very accurate, they are not generalizable and the time and resources required to adopt them in any given domain pose significant hurdles that prevent broad adoption. Thus, a need exists for a named entity recognition solution that avoids these high training costs.

Some named entity recognition systems do exist that are not trained using supervised learning techniques. So-called unsupervised named entity recognition systems can locate and tag named entities in unstructured text without requiring training using a large corpus of high quality annotated data used. However, unsupervised named entity recognition systems are generally not as accurate as supervised named entity recognition systems. Accordingly, improvements in accuracy would render such systems far more applicable to a wider range of domains.

Current unsupervised named entity recognition systems utilize a reference named entity list, and tags named entities in input text by performing string matching between input text and each of the named entities in the reference named entity list. However, to attain high performance, the reference named entity list must be very large, which means that the number of string matching operations is enormous. Thus, current unsupervised named entity recognition systems are resource intensive and can be time-consuming to execute.

Accordingly, a need exists for enhancements in unsupervised named entity recognition that avoids the drawbacks of existing supervised and unsupervised named entity recognition techniques.

Systems, apparatuses, methods, and computer program products are disclosed herein for unsupervised named entity recognition that mitigates the hurdles of traditional approaches to named entity recognition. In one example embodiment, a method is provided for unsupervised named entity recognition. The method includes receiving, by a communications circuitry, a reference named entity list, the reference named entity list identifying a set of named entities and an entity type of each identified named entity, generating, by a vectorizer, vectors from the named entities identified in the reference named entity list, and consolidating, by a synthesizer, the generated vectors into a set of representative vectors, wherein each representative vector is associated with a particular entity type. The method further includes receiving, by an analysis engine, a set of text, and performing, by the analysis engine, named entity recognition on the set of text using the set of representative vectors to generate a tagged set of text.

In another example embodiment, an apparatus is provided for unsupervised named entity recognition. The apparatus includes communications circuitry configured to receive a reference named entity list, the reference named entity list identifying a set of named entities and an entity type of each identified named entity, and a vectorizer configured to generate vectors from the named entities identified in the reference named entity list. The apparatus further includes a synthesizer configured to consolidate the generated vectors into a set of representative vectors, wherein each representative vector is associated with a particular entity type, and an analysis engine configured to receive a set of text and perform named entity recognition on the set of text using the set of representative vectors to generate a tagged set of text.

In another example embodiment, a computer program product is provided for unsupervised named entity recognition. The computer program product comprising at least one non-transitory computer-readable storage medium storing software instructions that, when executed, cause an apparatus to receive a reference named entity list, generate vectors from the named entities identified in the reference named entity list, and consolidate the generated vectors into a set of representative vectors, wherein each representative vector is associated with a particular entity type. The software instructions, when executed, further cause the apparatus to, in response to receiving a set of text, perform named entity recognition on the set of text using the set of representative vectors to generate a tagged set of text.

The foregoing brief summary is provided merely for purposes of summarizing example embodiments illustrating some aspects of the present invention. Accordingly, it will be appreciated that the above-described embodiments are merely examples and should not be construed to narrow the scope of the present disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used for unsupervised named entity recognition.

FIG. 2 illustrates a schematic block diagram of example circuitry embodying a device that may perform various operations in accordance with some example embodiments described herein.

FIG. 3 illustrates an example flowchart for unsupervised named entity recognition, in accordance with some example embodiments described herein.

FIG. 4 illustrates an example flowchart for consolidating a set of vectors for a reference named entity list into a set of representative vectors, in accordance with some example embodiments described herein.

FIG. 5 illustrates an example illustration of vector consolidation, as may be used in some example embodiments described herein.

FIG. 6 illustrates another example flowchart for unsupervised named entity recognition using a set of representative vectors, in accordance with some example embodiments described herein.

FIG. 7 illustrates an example illustration of a cosine similarity comparison process, as may be used in some example embodiments described herein.

### DETAILED DESCRIPTION

Some embodiments of the invention will now be described more fully hereinafter with reference to the accompanying figures, in which some, but not all, embodiments are shown. Indeed, the inventions may be embodied in many different forms and should not be construed as limited to the embodiments set forth herein; rather, these embodiments are provided so that this disclosure will satisfy applicable legal requirements.

The term “computing device” is used herein to refer to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” is used to refer to any computing device capable of functioning as a server, such as a master exchange server, web server, mail server, document server, or any other type of server. A server may be a dedicated computing device or a server module (e.g., an application) hosted by a computing device that causes the computing device to operate as a server.

### Overview

As noted above, methods, apparatuses, systems, and computer program products are described herein that provide for unsupervised named entity recognition. Using traditional techniques, it is time-consuming and costly to produce a supervised named entity recognition system. And historical unsupervised named entity recognition systems have generally lower accuracy than their supervised counterparts, while also requiring computationally expensive operations during run-time. Accordingly, a need exists for improved named entity recognition that addresses the drawbacks of current approaches.

In contrast to these conventional techniques for named entity recognition, the present disclosure describes a new named entity recognition solution that is unsupervised (and thus avoids the need for a large corpus of labeled data), but which demonstrates improved accuracy and significantly improved runtime efficiency and performance. Example implementations gather a reference named entity list and vectorizer the named entities in the list. Example embodiments thereafter consolidate the generated vectors using a clustering technique to produce a set of representative vectors. When new input is received, it is vectorized and compared to the representative vectors using cosine similarity calculations, from which entity types are identified for the various named entities in the new input. Because the new input is only compared to the representative vectors of clusters of named entities rather than to vectors of all of the reference named entities in the reference named entity list, example solutions set forth herein produce a significant enhancement in efficiency of operation over traditional unsupervised named entity recognition systems. Moreover, example solutions are in fact more accurate than state-of-the-art unsupervised named entity recognition techniques, as documented below. And, of course, because example solutions set forth herein are unsupervised, they overcome the traditional resource-intensity issues endemic to supervised named entity recognition systems.

Although a high level explanation of the operations of example embodiments has been provided above, specific details regarding the configuration of such example embodiments are provided below.

### System Architecture

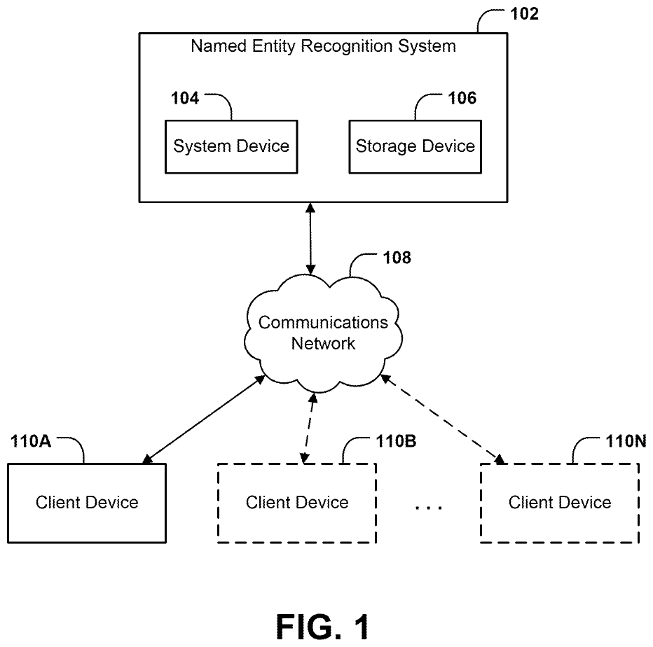

Example embodiments described herein may be implemented using any of a variety of computing devices or servers. To this end, FIG. 1 illustrates an example environment within which example embodiments may operate. As illustrated, a named entity recognition system 102 may include a system device 104 in communication with a storage device 106. Although system device 104 and storage device 106 are described in singular form, some embodiments may utilize more than one system device 104 and/or more than one storage device 106. Additionally, some embodiments of the named entity recognition system 102 may not require a storage device 106 at all. Whatever the implementation, the named entity recognition system 102, and its constituent system device(s) 104 and/or storage device (s) 106 may receive and/or transmit information via communications network 108 (e.g., the Internet) with any number of other devices, such as one or more of client device 110A, client device 110B, through client device 110N.

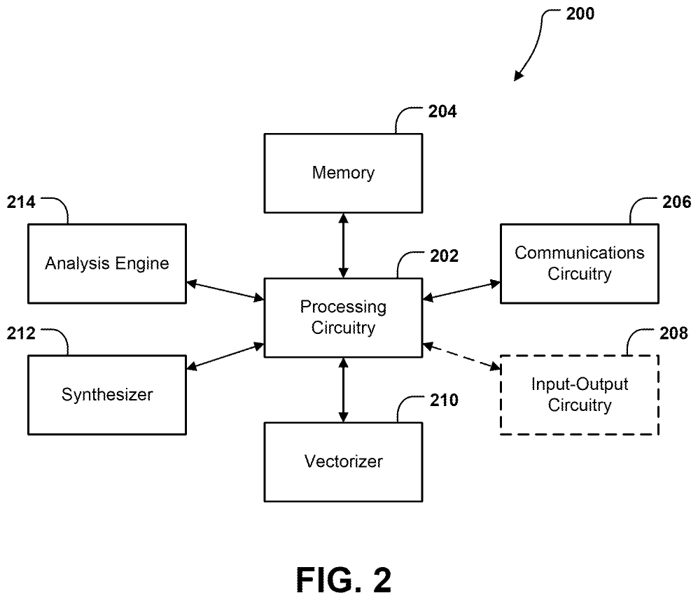

System device 104 may be implemented as one or more servers, which may or may not be physically proximate to other components of the named entity recognition system 102. Furthermore, some components of system device 104 may be physically proximate to the other components of the named entity recognition system 102 while other components are not. System device 104 may receive, process, generate, and transmit data, signals, and electronic information to facilitate the operations of the named entity recognition system 102. Particular components of system device 104 are described in greater detail below with reference to apparatus 200 in connection with FIG. 2.

Storage device 106 may comprise a distinct component from system device 104, or may comprise an element of system device 104 (e.g., memory 204, as described below in connection with FIG. 2). Storage device 106 may be embodied as one or more direct-attached storage (DAS) devices (such as hard drives, solid-state drives, optical disc drives, or the like) or may alternatively comprise one or more Network Attached Storage (NAS) devices independently connected to a communications network (e.g., communications network 108). Storage device 106 may host the software executed to operate the named entity recognition system 102 and/or the system device 104. Storage device 106 may store information relied upon during operation of the named entity recognition system 102, such as one or more reference named entity lists, various clustering algorithms or techniques that may be used for vector consolidation, predictive performance metrics that may be used by the named entity recognition system 102 to evaluate named entity recognition performance, sample input data to be used by the named entity recognition system 102 for testing purposes, or the like. In addition, storage device 106 may store control signals, device characteristics, and access credentials enabling interaction between the named entity recognition system 102 and one or more of client device 110A through client device 110N.

Client device 110A through client device 110N may be embodied by any computing devices known in the art, such as desktop or laptop computers, tablet devices, smartphones, or the like. Client device 110A through client device 110N need not themselves be independent devices, but may be peripheral devices communicatively coupled to other computing devices.

Although FIG. 1 illustrates an environment and implementation of the present invention in which the named entity recognition system 102 interacts with one or more of client device 110A through client device 110N, in some embodiments users may directly interact with the named entity recognition system 102 (e.g., via input/output circuitry of system device 104), in which case a separate client device may not be required. Whether by way of direct interaction or interaction via a separate client device, a user may communicate with, operate, control, modify, or otherwise interact with the named entity recognition system 102 to perform functions described herein and/or achieve benefits as set forth in this disclosure.

### Example Implementing Apparatuses

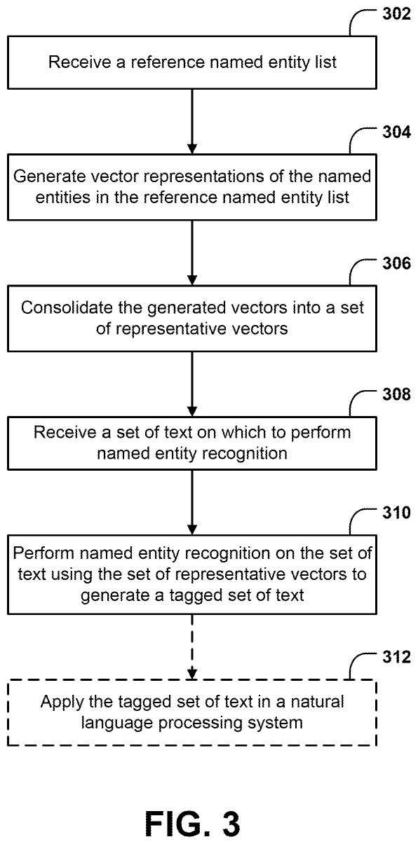

System device 104 of the named entity recognition system 102 may be embodied by one or more computing devices or servers, shown as apparatus 200 in FIG. 2. As illustrated in FIG. 2, the apparatus 200 may include processor 202, memory 204, communications circuitry 206, input-output circuitry 208, vectorizer 210, synthesizer 212, and analysis engine 214, each of which will be described in greater detail below. While the various components are only illustrated in FIG. 2 as being connected with processor 202, it will be understood that the apparatus 200 may further comprises a bus (not expressly shown in FIG. 2) for passing information amongst any combination of the various components of the apparatus 200. The apparatus 200 may be configured to execute various operations described above in connection with FIG. 1 and below in connection with FIGS. 3, 4, and 6.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor (e.g., software instructions stored on a separate storage device 106, as illustrated in FIG. 1). In some cases, the processor may be configured to execute hard-coded functionality. As such, whether configured by hardware or software methods, or by a combination of hardware with software, the processor 202 represent an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The communications circuitry 206 may be any means such as a device or circuitry embodied in either hardware or a combination of hardware and software that is configured to receive and/or transmit data from/to a network and/or any other device, circuitry, or module in communication with the apparatus 200. In this regard, the communications circuitry 206 may include, for example, a network interface for enabling communications with a wired or wireless communication network. For example, the communications circuitry 206 may include one or more network interface cards, antennas, buses, switches, routers, modems, and supporting hardware and/or software, or any other device suitable for enabling communications via a network. Furthermore, the communications circuitry 206 may include the processing circuitry for causing transmission of such signals to a network or for handling receipt of signals received from a network.

The apparatus 200 may include input-output circuitry 208 configured to provide output to a user and, in some embodiments, to receive an indication of user input. It will be noted that some embodiments will not include input-output circuitry 208, in which case user input may be received via a separate device such as a client device 112 (shown in FIG. 1). The input-output circuitry 208 may comprise a user interface, such as a display, and may further comprise the components that govern use of the user interface, such as a web browser, mobile application, dedicated client device, or the like. In some embodiments, the input-output circuitry 208 may include a keyboard, a mouse, a touch screen, touch areas, soft keys, a microphone, a speaker, and/or other input/output mechanisms. The input-output circuitry 208 may utilize the processor 202 to control one or more functions of one or more of these user interface elements through software instructions (e.g., application software and/or system software, such as firmware) stored on a memory (e.g., memory 204) accessible to the processor 202.

In addition, the apparatus 200 further comprises a vectorizer 210 configured to generate a vector representation of a word or other text string. A vector representation of a text string may be referred to as a word embedding. The vectorizer 210 may generate vectors from text strings using any of a number of different algorithms, such as fastText, word2vec (with either a continuous bag-of-words or skip-gram architecture), GloVe, or another neural network-based text vectorization technique. These algorithms and techniques may be implemented using software code stored in memory 204 or a separate storage device 106. The vectorizer 210 may leverage the processor 202 to execute the software code to generate a given vector from a given text string, or may leverage any other hardware component included in the apparatus 200 for this purpose. The vectorizer 210 may utilize communications circuitry 206 to receive a text string from any of a variety of sources (e.g., client device 110A through client device 110N or storage device 106, as shown in FIG. 1), or may utilize input-output circuitry 208 to receive the text string directly from a user or peripheral device. The vectorizer 210 may also utilize communications circuitry 206 or input-output circuitry 208 to transmit a generated vector representation to a separate device or user, or may transmit the vector representation to another component of the apparatus 200, such as the synthesizer 212 or analysis engine 214.

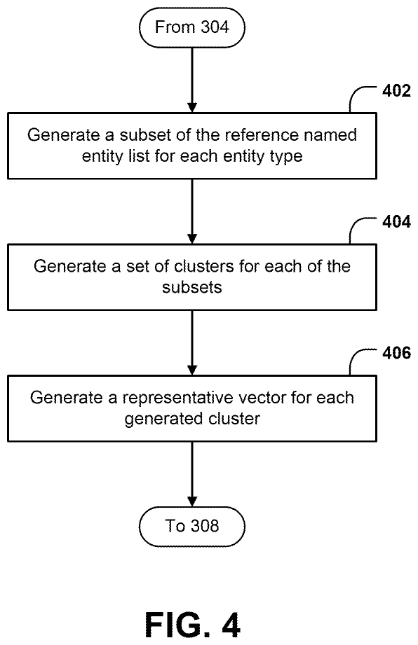

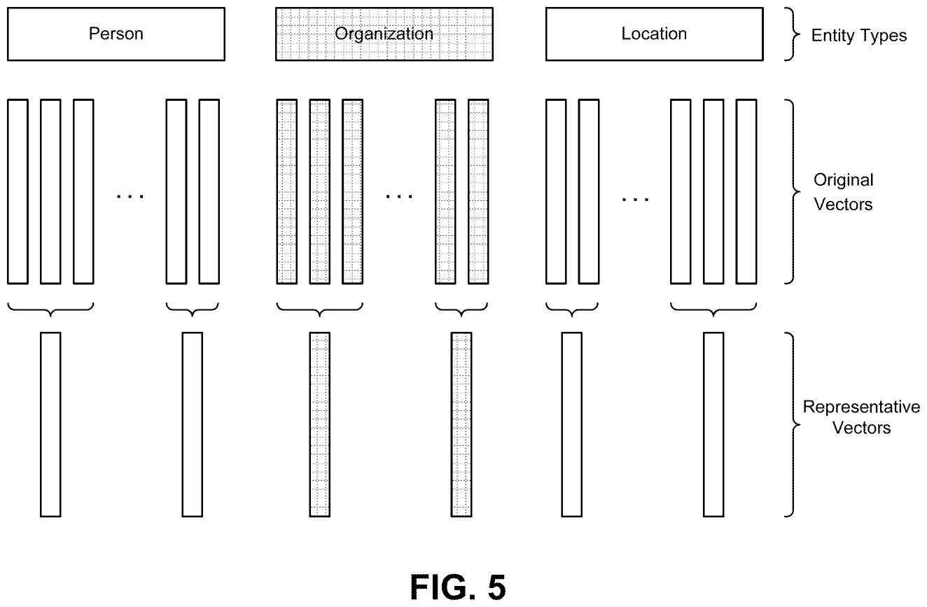

The apparatus 200 further comprises a synthesizer 212 configured to consolidate a set of vectors for a reference named entity list into a set of representative vectors for the various entity types identified in the reference named entity list. The synthesizer 212 may utilize processor 202, memory 204, or any other hardware component included in the apparatus 200 to perform these operations, which are described in greater detail below in connection with FIGS. 4 and 5. For instance, the synthesizer 212 may leverage the processor 202 to execute software code stored in memory 204 or a separate storage device 106 in order to execute the various vector consolidation operations described in connection with the flowcharts set forth in FIGS. 3 and 4 and in the illustration set forth in FIG. 5. The synthesizer 212 may retrieve the set of vectors for a reference named entity list from vectorizer 210 or memory 204, or may utilize communications circuitry 206 to receive the set of vectors for a reference named entity list from any of a number of other sources (e.g., client device 110A through client device 110N or storage device 106, as shown in FIG. 1), or may even utilize input-output circuitry 208 to receive the set of vectors directly from a user or peripheral device. The synthesizer 212 may also utilize communications circuitry 206 or input-output circuitry 208 to transmit a consolidated set of representative vectors to a separate device (e.g., storage device 106, client device 110A through client device 110N, or a peripheral device) or for presentation to a user, or may transmit the consolidated set of representative vectors to another component of the apparatus 200, such as the analysis engine 214 or memory 204.

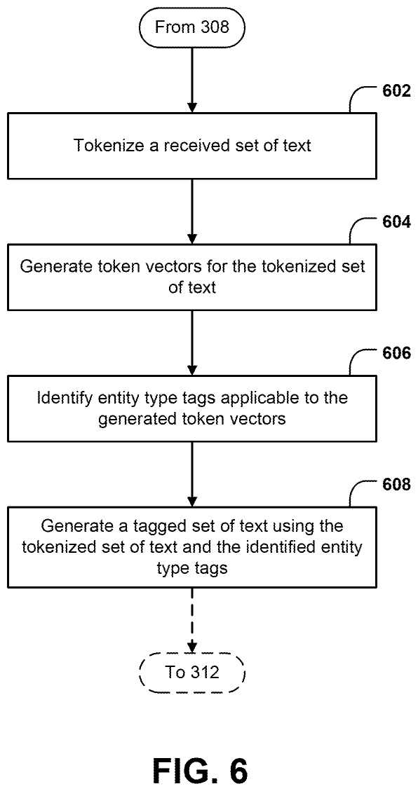

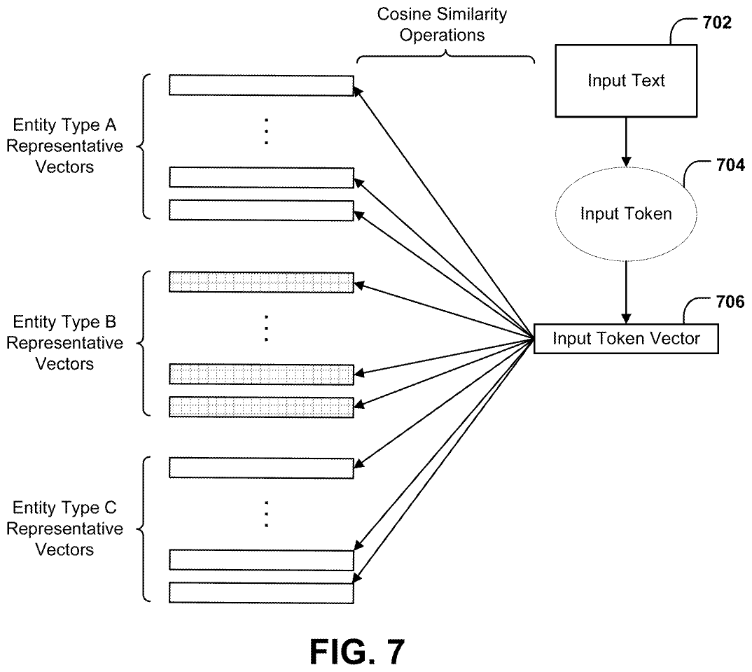

In addition, the apparatus 200 further comprises an analysis engine 214 configured to perform named entity recognition to tag a set of text and, in some embodiments, to thereafter utilize the tagged set of text in support of additional natural language processing operations. The analysis engine 214 may utilize processor 202, memory 204, or any other hardware component included in the apparatus 200 to perform these operations. For instance, the analysis engine 214 may leverage the processor 202 to execute software code stored in memory 204 or a separate storage device 106 in order to execute the various vector consolidation operations described in connection with the flowcharts set forth in FIGS. 3 and 6 and in the illustration set forth in FIG. 7. The analysis engine 214 may retrieve the consolidated set of representative vectors for a reference named entity list from synthesizer 212 or memory 204, may utilize communications circuitry 206 to receive the consolidated set of representative vectors from any of a number of other sources (e.g., client device 110A through client device 110N or storage device 106, as shown in FIG. 1), or may even utilize input-output circuitry 208 to receive the consolidated set of representative vectors directly from a user or peripheral device. Similarly, the analysis engine 214 may retrieve the set of text to be tagged from memory 204, may utilize communications circuitry 206 to receive the set of text to be tagged from any of a number of other sources (e.g., client device 110A through client device 110N or storage device 106, as shown in FIG. 1), or may utilize input-output circuitry 208 to receive the set of text to be tagged directly from a user or peripheral device. The analysis engine 214 may also utilize communications circuitry 206 or input-output circuitry 208 to transmit a tagged set of text to a separate device (e.g., storage device 106, client device 110A through client device 110N, or a peripheral device) or for presentation to a user, or may transmit the consolidated set of representative vectors to another component of the apparatus 200, such as the memory 204. If further natural language processing operations are performed, the tagged set of text may simply be further utilized by the analysis engine 214 in such operations.

Although components 202-214 are described in part using functional language, it will be understood that the particular implementations necessarily include the use of particular hardware. It should also be understood that certain of these components 202-214 may include similar or common hardware. For example, the vectorizer 210, synthesizer 212, and analysis engine 214 may at times leverage use of the processor 202, memory 204, communications circuitry 206, or input-output circuitry 208, such that duplicate hardware is not required to facilitate operation of these physical elements of the apparatus 200 (although dedicated hardware elements may be used for any of these components in some embodiments, such as those in which enhanced parallelism may be desired). Use of the terms “circuitry,” and “engine” with respect to elements of the apparatus therefore shall be interpreted as necessarily including the particular hardware configured to perform the functions associated with the particular element being described. Of course, while the terms “circuitry” and “engine” should be understood broadly to include hardware, in some embodiments, the terms “circuitry” and “engine” may in addition refer to software instructions that configure the hardware components of the apparatus 200 to perform the various functions described herein.

Although the vectorizer 210, synthesizer 212, and analysis engine 214 may leverage processor 202, memory 204, communications circuitry 206, and/or input-output circuitry 208 as described above, it will be understood that each of these elements of apparatus 200 may include one or more dedicated processor, specially configured field programmable gate array (FPGA), or application specific interface circuit (ASIC) to perform its corresponding functions, and may accordingly leverage processor 202 executing software stored in a memory (e.g., memory 204), or memory 204, communications circuitry 206 or input-output circuitry 208 for enabling any functions not performed by special-purpose hardware elements. In all embodiments, however, it will be understood that the vectorizer 210, synthesizer 212, and analysis engine 214 are implemented via particular machinery designed for performing the functions described herein in connection with such elements of apparatus 200.

In some embodiments, various components of the apparatus 200 may be hosted remotely (e.g., by one or more cloud servers) and thus need not physically reside on the apparatus 200. Thus, some or all of the functionality described herein may be provided by third party circuitry. For example, the apparatus 200 may access one or more third party circuitries via any sort of networked connection that facilitates transmission of data and electronic information between the apparatus 200 and the third party circuitries. In turn, the apparatus 200 may be in remote communication with one or more of the other components describe above as comprising the apparatus 200.

As will be appreciated based on this disclosure, example embodiments contemplated herein may be implemented by apparatus 200. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, flash memory, optical storage devices, and magnetic storage devices. It should be appreciated, with respect to certain devices embodied by apparatus 200 as described in FIG. 2, that loading the software instructions onto a computing device or apparatus produces a special-purpose machine comprising the means for implementing various functions described herein.

Having described specific components of an example apparatus 200 that may implement various example embodiments, some of those example embodiments are described below in connection with a series of flowcharts and illustrations.

### Example Operations

Turning to FIGS. 3, 4, and 6, flowcharts are illustrated that contains example operations for performing unsupervised named entity recognition in a way that avoids many of the drawbacks of traditional named entity recognition systems. The operations illustrated in FIGS. 3, 4, and 6 may, for example, be performed by system device 104 of the named entity recognition system 102 shown in FIG. 1, which may in turn be embodied by an apparatus 200, which is shown and described in connection with FIG. 2. To perform the operations described below, the apparatus 200 may utilize one or more of processing circuitry 202, memory 204, communications circuitry 206, input-output circuitry 208, vectorizer 210, synthesizer 212, and analysis engine 214, and/or any combination thereof. It will be understood that user interaction with the named entity recognition system 102 may occur directly via input-output circuitry 208, or may instead be facilitated by a separate client device 110, as shown in FIG. 1, and which may have similar or equivalent physical componentry facilitating such user interaction.

As shown by operation 302, the apparatus 200 includes means, such as memory 204, communications circuitry 206, input-output circuitry 208, or the like, for receiving a reference named entity list. The reference named entity list contains named entities of predefined categories (i.e., entity types), such as PERSON, LOCATION, and ORGANIZATION. The reference named entity list may comprise a set of lists, one for each entity type, or it may comprise a data structure of any suitable kind that identifies the various named entities and their corresponding predefined entity types. For instance, an example reference named entity list having three entries (for the entities “Peter” having an entity type PERSON, “London” having an entity type LOCATION, and “BBC”, having an entity type ORGANIZATION) may be the following:

[Peter, PERSON], [London, LOCATION], [BBC, ORGANIZATION]

To achieve high model performance, the reference named entity list needs to be large enough that it is likely to cover the named entities in a given set of text upon which named entity recognition will be performed. But as noted previously, performing string matching between each entity in a set of text and all of the named entities in a large reference named entity list will be time-consuming and demand significant resource allocation. Subsequent operations of FIG. 3 that are described below illustrate how the present invention alleviates these issues.

It will be understood that the reference named entity list may be received in various ways and from various sources. For instance, the reference named entity list may be built using data from a variety of sources, such as public repositories, proprietary data stores, or combinations of the same. To this end, some or all of the records in the reference named entity list may have been previously stored by a storage device 106, which may comprise memory 204 of the apparatus 200 or a separate storage device. In such scenarios, the apparatus 200 may simply retrieve the previously stored reference named entity list from the memory 204 or a local storage device 106, or communications circuitry 206 may receive the previously stored reference named entity list from a remote storage device 106. In another example, some or all of the reference named entity list may be provided by a separate device (e.g., one of client device 110A through client device 110N), in which case the apparatus 200 may leverage communications circuitry 206 to receive the relevant portion of the reference named entity list from that separate device. In another example, some or all of the reference named entity list may be provided directly to the apparatus 200 through user data entry or from a peripheral device, in which case the input-output circuitry 208 may receive the relevant portion of the reference named entity list. Of course, the apparatus 200 may receive the reference named entity list from a combination of these sources, and where the reference named entity list gathers information from multiple sources, the apparatus 200 may further include means, such as processor 202 or the like, for generating the reference named entity list from the various constituent components gather from the multiple sources. This may include the processor 202 concatenating multiple sets of records together, and/or it may the processor 202 performing one or more pre-processing operations to remove unneeded data elements from various records, to reorganize the records from the multiple sources into a singular data format, or to remove duplicated records prior to concatenation of the sets of records.

Turning next to operation 304, the apparatus 200 includes means, such as vectorizer 210 or the like, for generating vector representations of the named entities in the reference named entity list. These vector representations may also be referred to as word embeddings and, for the sake of clarity, will be referred to herein just as “vectors.” Having previously received the reference named entity list, the vectorizer 210 may generate these vectors from the named entities in the reference named entity list. In this regard, the vectorizer 210 may generate a distinct vector for each distinct named entity in the reference named entity list. The vectorizer 210 may generate these vectors using any of a number of different algorithms, such as fastText, word2vec (with either a continuous bag-of-words or skip-gram architecture), GloVe, or another neural network-based text vectorization technique. The vectors generated using these techniques may inherit contextual information about their corresponding named entities, such as the word's semantic meaning, but also sub-word information, indicating morphological construction. Accordingly, the reference named entity list is transformed from a set of records a list of vectors in which each vector represents a corresponding word (in some embodiments, these vectors may contain 300 real numbers, although fewer or more numbers may be adequate or required in various other embodiments).

While not specifically noted in FIG. 3, the vectorizer 210 may further store the generated vectors in memory 204, or a local storage device 106, may leverage communications circuitry 206 to transmit the generated vectors to a remote storage device 106 or client device 110A through client device 110N, or may leverage input-output circuitry 208 to present the generated vectors to a user via an interface or to store the generated vectors using a peripheral device connected to the apparatus 200. Storage or transmission of the generated vectors enables subsequent use of those vectors without requiring real-time generation of the vectors. For instance, the apparatus 200 may perform operations 302 and 304 in an initial procedure to generate the vectors for a reference named entity list, but may thereafter store the generated vectors for use at a later time. In another example, a first apparatus 200 may generate the vectors, and may store them such that a second apparatus 200 may utilize the generated vectors for subsequent steps in the procedure set forth herein.

As shown by operation 306, the apparatus 200 includes means, such as synthesizer 212 or the like, for consolidating the generated vectors into a set of representative vectors for the reference named entity list, wherein each representative vector is associated with a particular entity type. Greater detail about how the synthesizer 212 may perform this consolidation operation is provided below in connection with FIGS. 4 and 5, which will now be described.

Turning to FIG. 4, a more detailed series of operations are shown for consolidating a set of vectors for a reference named entity list into a set of representative vectors.

As shown by operation 402, the apparatus 200 includes means, such as synthesizer 212 or the like, for generating a subset of the reference named entity list for each entity type. In embodiments where the reference named entity list already comprises discrete reference named entity lists for each entity type, this step may not be necessary as the discrete reference named entity lists can be used in the subsequent operations described below. However, in embodiments where the reference named entity list comprises a holistic list of records, where each record identifies a named entity and its corresponding entity type, or where the reference named entity list may comprise a more complex data structure, operation 402 enables creation of the subsets of the reference named entity list needed for the consolidation operations described herein. To this end, operation 402 illustrates that the synthesizer 212 is configured to generate the subsets of the reference named entity list for each entity type by defining new subsets of the reference named entity list for the various entity types, and then iterating through the records in the reference named entity list and allocating each record to its appropriate subset. In this fashion, synthesizer 212 generates multiple subsets of the reference named entity list, each subset comprising all of the named entities in the reference named entity list having a corresponding entity type.

As shown by operation 404, the apparatus 200 includes means, such as synthesizer 212 or the like, for generating a set of clusters for each of the subsets. The synthesizer may generate the set of clusters for a particular subset of the reference named entity list by applying any of a number of clustering techniques, such as a centroid-based clustering technique like k-means clustering, or other techniques such as a hierarchical clustering, distribution-based clustering, density-based clustering, and grid-based clustering techniques.

For instance, the synthesizer 212 may utilize a k-means clustering technique by applying k-means clustering to each subset of the reference named entity list to produce a set of clusters of named entities corresponding to each subset of the reference named entity list. To apply k-means clustering to a particular subset of the reference named entity list, the synthesizer 212 initially specifies a desired number of clusters for the particular subset of the reference named entity list. In some embodiments, the same number of clusters may be used for every subset of the reference named entity list, although in other embodiments the number of clusters to be used for a given subset of the reference named entity list may vary based on the specific context.

In order to optimize the named entity recognition solution described herein, the number of clusters for a given subset comprises a hyperparameter that may be tuned in conjunction with a predefined decision threshold demarcating whether a particular input token should be tagged with a particular entity type during named entity recognition (the manner by which the decision threshold is utilized during named entity recognition is described below in connection with FIG. 6.). To tune these hyperparameters, example implementations may leverage performance metrics for the unsupervised named entity recognition process, and the apparatus 200 may iteratively modify these hyperparameters in a way that maximizes performance and cost-corrected performance. For instance, a first performance metric that may be used is the F1 score, which is represented with the following equation:

$$F 1 = 2 \times \frac{P r e c i s i o n \times R e c a l l}{P r e c i s i o n + R e c a l l}$$

The F1 score has a value between 0 and 1, with the highest possible value being 1 and indicating a perfect precision and also perfect recall, and the lowest possible value being 0, indicating zero precision and zero recall.

A second performance metric is a cost-corrected F1 score, which is represented by the following equation:

$$Cost Corrected F 1 = \frac{F 1 Score}{Runtime in seconds}$$

The cost-corrected F1 score is a metric that shows the balance between model performance (the F1 score itself) and algorithm efficiency (runtime). A better model is expected to have a higher numerator (e.g., higher performance) but a lower denominator (e.g., lower runtime). Using the F1 score and the cost-corrected F1 score, the apparatus 200 may identify both a number of clusters to use in the clustering operation, as well as the decision threshold demarcating whether a particular input token should be tagged.

Following specification of a desired number of clusters for a particular subset of the reference named entity list, however, the synthesizer 212 may assign each named entity in a given subset to one of the clusters and then iteratively optimize the cluster assignments. The synthesizer 212 may optimize the cluster assignments by repeatedly (i) calculating a centroid for each cluster based on the named entities assigned to that cluster, and (ii) re-assigning each named entity in the subset of the reference named entity list to the cluster whose centroid is closest in Euclidean distance to the vector generated from the named entity, and then repeating steps (i) and (ii) until cluster assignments stop changing.

Finally, as shown by operation 406, the apparatus 200 includes means, such as vectorizer 210, synthesizer 212, or the like, for generating a representative vector for each generated cluster. To do this, the synthesizer 212 may calculate an element-wise mean of the vectors corresponding to the named entities in each particular cluster, such that the element-wise mean is the representative vector for that particular cluster. In this fashion, the synthesizer 212 generates the set of representative vectors for the various clusters identified in operation 404. It will be understood that, just as each cluster corresponds to reference named entities having a particular entity type, each representative vector of a particular cluster thus corresponds to the particular entity type of that cluster.

FIG. 5 provides a visual illustration of this consolidation procedure. In a given reference named entity list, there may be any number of entity types, although a typical embodiment may include three entity types of interest: PERSON, ORGANIZATION and LOCATION. As described in connection with operation 304 above, the apparatus 200 may generate a vector representation of each of the named entities in the reference named entity list, from which a subset of vectors is defined for each entity type. For each of the entity types at the top of FIG. 5, these “original vectors” are shown in the middle of the illustration. Thereafter, FIG. 4 describes operations that cut down the size of reference named entity list by consolidating the subset reference named entity list of each entity type, first by applying a clustering technique to group each entity type's subset of named entities into a number of clusters, and then by calculating element-wise arithmetic mean of the vectors in each cluster to form representative vectors of each reference named entity list subset. These representative vectors are illustrated at the bottom of FIG. 5. As can be seen visually, an initial series of vectors is reduced to a smaller number of vectors, which increases efficiency (and, in fact, accuracy) in follow-on string matching and entity type classification operations.

In an example scenario where a reference named entity list has an entity type PERSON, the synthesizer 212 will consolidate, for example, the subset of reference named entity list of PERSON. There may be many thousands of named entities having the entity type person, and thus many thousand original vectors representative of the named entities having the PERSON entity type PERSON. The synthesizer 212 applies a clustering technique, such as k-means clustering, to these original vectors in order to group these original vectors into, in this example, one thousand clusters. One of the clusters contains four vectors as follow:
Andy [0.213392−0.238999 . . . −0.158634 0.516251]
Mary [−0.301692 0.282509 . . . 0.068034 −0.090852]
Dave [0.144020 −0.182312 . . . 0.006196 0.190559]
Madelyn [−0.154769 0.142334 . . . −0.285709 0.390034]

The representative vector of this cluster is calculated from the element-wise mean of the four person names' embedding vectors:
Representative vector: [0.024760 0.000883 . . . 0.092530 0.251498]

By the end of this step, the synthesizer 212 has thus generated one thousand representative embedding vectors that will be used in further analysis instead of original vectors.

While not specifically noted in FIG. 3, 4, or 5, the synthesizer 212 may further store the set of representative vectors in memory 204, or a local storage device 106, may leverage communications circuitry 206 to transmit the set of representative vectors to a remote storage device 106 or client device 110A through client device 110N, or may leverage input-output circuitry 208 to present the set of representative vectors to a user via an interface or to store the set of representative vectors using a peripheral device connected to the apparatus 200. Storage or transmission of the set of representative vectors enables subsequent use of the set of representative vectors without requiring real-time generation thereof. For instance, the apparatus 200 may perform operations 302-306 in an initial procedure to generate the set of representative vectors for a reference named entity list, but may thereafter store the set of representative vectors for use at a later time. In another example, a first apparatus 200 may generate the set of representative vectors, and may store them such that a second apparatus 200 may utilize the set of representative vectors for subsequent steps in the procedure set forth herein.

Whether used immediately after its generation stored for use at a later time, the set of representative vectors generated in the manner described above enables performance of named entity recognition as will be outlined below. Because the set of representative vectors is smaller than the original set of generated vectors, the named entity recognition process will be more efficient (i.e., require fewer computing resources) and will also execute more quickly than performing named entity recognition using the original set of generated vectors. Moreover, using this set of representative vectors instead of the full set of generated vectors in fact increases the accuracy of subsequently performed named entity recognition, likely because the use of representative vectors in place of the full set of vectors better generalizes the similarity analysis performed during named entity recognition.

Returning to the discussion of FIG. 3, operation 308 illustrates that the apparatus 200 includes means, such as memory 204, communications circuitry 206, input-output circuitry 208, analysis engine 214, or the like, for receiving a set of text on which to perform named entity recognition. This set of text may be received in various ways and from various sources. For instance, the set of text may have been previously stored by a storage device 106, which may comprise memory 204 of the apparatus 200 or a separate storage device. In such scenarios, the apparatus 200 may simply retrieve the previously stored set of text from the memory 204 or a local storage device 106, or communications circuitry 206 may receive the previously stored set of text from a remote storage device 106. In another example, some or all of the set of text may be provided by a separate device (e.g., one of client device 110A through client device 110N), in which case the apparatus 200 may leverage communications circuitry 206 to receive the relevant portion of the set of text from that separate device. In another example, some or all of the set of text may be provided directly to the apparatus 200 through user data entry or from a peripheral device, in which case the input-output circuitry 208 may receive the relevant portion of the set of text. Of course, the apparatus 200 may receive the set of text from a combination of these sources, such as where a base input string is received from a memory or storage via communications circuitry 206 and supplemented by user input received via input-output circuitry 208, or where some of the input string is received by the communications circuitry 206 from a first client device (e.g., client device 110A) and supplemented by user input received by the communications circuitry 206 from a second client device (e.g., client device 110B).

As shown by operation 310, the apparatus 200 includes means, such as analysis engine 214 or the like, for performing named entity recognition on the set of text using the set of representative vectors to generate a tagged set of text. Greater detail about how the analysis engine 214 may perform this operation is provided below in connection with FIGS. 6 and 7, which will now be described.

Turning first to FIG. 6, a more detailed series of operations are shown for performing unsupervised named entity recognition using the set of representative vectors for the reference named entity list.

As shown by operation 602, the apparatus 200 includes means, such as analysis engine 214 or the like, for tokenizing a received set of text. Tokenization, in this regard, refers generally to breaking components of the set of text into individual linguistic units. For instance, the analysis engine 214 may use white space to demarcate the boundary between linguistic units in the set of text. Accordingly, the analysis engine 214 may tokenize the set of text by creating tokens for every set of characters in the text that is separated by white space from the other characters in the set of text. For instance, in the string “Joe Biden is the President,” the analysis engine may identify five tokens (“Joe”, “Biden”, “is”, “the”, and “President”). More sophisticated tokenization procedure may be used in some embodiments. For instance, rather than simply using white space to demarcate the boundaries between tokens, the analysis engine 214 may identify multi-word tokens in certain scenarios. For instance, with the input string “Joe Biden is the President,” a more sophisticated tokenization operation may generate four distinct tokens (“Joe Biden”, “is”, “the”, and “President”), reflective of a more nuanced determination that Joe Biden is a single entity rather than two entities. The specific type of tokenization used may vary by embodiment, but in any event the tokenized set of text may be used in subsequent operations for named entity recognition.

To that end, as shown by operation 604, the apparatus 200 includes means, such as vectorizer 210, analysis engine 214, or the like, for generating token vectors for the tokenized set of text. In this regard, the analysis engine 214 may itself generate a vector representation for each token produced in operation 602, or the analysis engine 214 may leverage vectorizer 210 to generate a vector representation of one or more of the tokens.

As shown by operation 606, the apparatus 200 includes means, such as analysis engine 214 or the like, for identifying entity type tags applicable to the generated token vectors. For any given token vector, the analysis engine 214 may calculate a cosine similarity between that token vector and every representative vector of the set of representative vectors for the reference named entity list. In doing so, the analysis engine 214 may produce similarity scores for each representative vector. Subsequently, the analysis engine 214 may identify the representative vector for which the cosine similarity between the token vector and the representative vector produces the highest similarity score. Thereafter, the analysis engine 214 may determine if the similarity score of the identified representative vector exceeds a predefined decision threshold, in which case the analysis engine 214 may then identify that an entity tag is appropriate for the token vector. Accordingly, the analysis engine 214 will select the entity type tag for the token vector that corresponds to the entity type associated with the identified representative vector. The analysis engine 214 will then repeat this process for each token vector generated from the received set of text. It will be understood that the predefined decision threshold comprises another hyperparameter that may be adjusted in any given implementation. The decision threshold is used to determine whether a cosine similarity score is high enough to label the input token as an entity type, in the tagging process. The higher the threshold, the less input text would be labeled as entity names. However, the lower the threshold, the more possibility of an erroneous entity type tag being applied to an input token.

As shown by operation 608, the apparatus 200 includes means, such as analysis engine 214 or the like, for generating a tagged set of text using the tokenized set of text and the identified entity type tags. This tagged set of text may, in one example be generated by taking the initial set of text and inserting annotations reflective of any tags selected for tokens from the set of text. For instance, given the set of text “Joe Biden is the President,” the tagged set of text may comprise the string “[Joe]_{Person} [Biden]_{Person} is the President” (or “[Joe Biden]Person is the President”, if “Joe Biden” is identified as a singular token).

FIG. 7, in turn, provides a visual illustration of the unsupervised named entity recognition procedure using representative vectors generated for a reference named entity list. As noted previously, the analysis engine 214 may receive a set of text 702 and may tokenize the set of text to produce a set of input tokens 704. For each input token 704, a corresponding token vector 706 may be generated. Subsequently, the analysis engine 214 may calculate the cosine similarity score between an individual token vector 706 and every representative vector for the reference named entity list. The highest similarity score from all of the cosine similarity calculations is then compared with a predefined decision threshold. If it exceeds the threshold, then the analysis engine 214 determines that the token in question should be tagged with the entity type corresponding to the representative vector from which the highest cosine similarity score was produced. This process is repeated for each input token, such that any appropriate entity type tags for any tokens are identified. Following the identification of appropriate entity type tags, the tagged set of text may be created as described previously in connection with operation 608.

Following performance of these operation, the procedure may return to operation 312 as described in connection with FIG. 3.

Specifically, operation 312 illustrates that the apparatus 200 may include means, such as communications circuitry 206, input-output circuitry 208, analysis engine 214, or the like, for applying the tagged set of text in a natural language processing system. It will be understood that the analysis engine 214 of apparatus 200 may comprise the natural language processing system, although in some embodiments the natural language processing system may comprise a different device. Where the analysis engine 214 comprises the natural language processing system, the tagged set of text may thus be stored by memory 204 for continued use by the analysis engine 214. However, storage or transmission of the tagged set of text enables subsequent use of the tagged set of text by another natural language processing system. To this end, the analysis engine 214 may leverage communications circuitry 206 to transmit the set of representative vectors to a remote storage device 106 or client device 110A through client device 110N, or may leverage input-output circuitry 208 to present the tagged set of text to a user via an interface or to store the tagged set of text using a peripheral device connected to the apparatus 200. In doing so, the apparatus 200 may store the tagged set of text for use at a later time, but may also enable use of the tagged set of text by a different device. For instance, a first apparatus 200 may generate the tagged set of text, and may store the tagged set of text such that a second apparatus 200 may utilize the tagged set of text for natural language processing. This may promote greater parallelization of the natural language processing by distributing various aspects of a natural language processing system to various devices within an environment. Alternatively, this bifurcated model may enable provision of named entity recognition by a central server device to be delivered as a service to other devices and users for any number of uses.

Whether used by the apparatus 200 or another device comprising the natural language processing system, the tagged set of text facilitates the extraction of information from the unstructured initial set of text, which is applicable to a wide range of domains. Some examples of these use cases include resume filtering, chatbots, and news scanning.

In a resume filtering implementation, performance of unsupervised NER by apparatus 200 enables the subsequent evaluation of resumes for a company interested in hiring new employees having particular skills. By initially selecting entity types relevant to a particular job search and building a corresponding reference entity list in operation 302 that identifies named entities having those initially selected entity types, a set of representative vectors may be generated in operation 306 that can be used for unsupervised named entity recognition on a set of text received in operation 308 that comprises one or more resumes. The unsupervised named entity recognition process performed in operation 310 will locate and label named entities of appropriate entity type, such as degree types, majors, institutions, and the like. In turn, the analysis engine 214 or other device performing natural language processing can identify a subset of candidates whose resumes may be relevant to one or another particular job search.

In a chatbot (e.g., virtual assistant) implementation, performance of unsupervised NER by apparatus 200 enables the real-time provision of information to a user relevant to statements or questions made by the user to the chatbot. One example chatbot implementation may be for an online medical platform, because medical and pharmaceutical names are difficult to capture using supervised named entity recognition. Accordingly, the unsupervised named entity recognition solutions described herein may be particularly useful in this sort of implementation. By initially selecting entity types relevant to the medical field, including entity types corresponding to various medical and pharmaceutical terminology, and then building a corresponding reference entity list in operation 302 that identifies named entities having those initially selected entity types, a set of representative vectors may be generated in operation 306 that can be used for unsupervised named entity recognition on a set of text received in operation 308 that comprises one or more statements or questions by a user interacting with an online chatbot. The unsupervised named entity recognition process performed in operation 310 will locate and label named entities of appropriate entity type in the text provided by a user. In turn, the analysis engine 214 or other device performing natural language processing can identify a related and useful resources based on the entity types identified in the user's questions or statements.

In a news scanning implementation, performance of unsupervised NER by apparatus 200 enables the real-time provision of relevant information based on news headlines and articles. One example implementation may be for those managing investments, in which it may be useful to identify companies for investigation based on general or financial news. By initially selecting entity types relevant to investments or financial services and then building a corresponding reference entity list in operation 302 that identifies named entities having those initially selected entity types, a set of representative vectors may be generated in operation 306 that can be used for unsupervised named entity recognition on a set of text received in operation 308 that comprises one or more news headlines or articles that may be automatically presented to an apparatus 200 from time to time. The unsupervised named entity recognition process performed in operation 310 will locate and label named entities of appropriate entity type in the text provided by a user. In turn, the analysis engine 214 or other device performing natural language processing can identify a list of companies that are relevant to the news headlines or articles, which can thereafter be used as a set of companies on which to focus investment decisions for the day.

As described herein, example embodiments address both technical problems and produce technical enhancements over traditional named entity recognition systems, and provide an efficient and accurate solution to locate and label named entities in unstructured text without requiring training of a named entity recognition model using pre-labeled datasets. The methodology described above is able to balance performance and system execution time through the selection of the number of clusters to be used for representative vectors for the reference named entity list and the predefined decision threshold to be used to determine when to tag an entity during performance of named entity recognition.

In relation to traditional unsupervised named entity recognition solutions, example embodiments described herein are significantly more efficient than traditional named entity recognition methodologies, in part due to much more efficient string matching operations in which new input need only be compared to the vectors representative of clusters of named entities rather than to vectors for each and every entity in a reference named entity list. For instance, Table 1 below shows a comparison of speed across large scale NER pipelines. This comparison is conducted among an example implementation described herein and two widely-used NLP pipelines: Stanford NLP and SENNA. And unlike the example implementations described herein, both the Stanford NLP and SENNA NER taggers are supervised systems. In Table 1, the term “tokens/sec” refers to how many tokens can be processed in a second. The higher this metric is, the more efficient the system is.

TABLE 1
Speed comparison with large-scale NER pipeline

| Resource | Dataset | Tokens/sec |
|---|---|---|
| Stanford | CONLL 2003 test | 11,612 |
| SENNA | CONLL 2003 test | 18,579 |
| Example Implementation | CONLL 2003 test | 29,796 |
| Described Herein | | |

As another illustration o the speed an efficiency improvements se o y the present invention, Table 2 below shows a speed comparison of speed across string-matching methods. This comparison is conducted between the RapidFuzz string matching algorithm and an example implementation described herein. All the other steps in the named entity recognition framework are kept the same such that the only difference is in the string matching algorithm used in the framework. The use of representative vectors as described herein reduces the average runtime of example embodiments so much that they can be as much as 50,000 to 70,000 times faster than fuzzy matching using the python module RapidFuzz.

TABLE 2
String matching speed comparison

| Resource | Dataset | Tokens/sec |
|---|---|---|
| RapidFuzz | CONLL 2003 test | 0.52 |
| Example Implementation | CONLL 2003 test | 29,796 |
| Described Herein | | |

These increases in efficiency and speed enable significant improvements in runtime, which allows use of these solutions in domains where time is of the essence, such as real-time natural language interaction environments. This increase in efficiency also enables significantly reduced resource allocation, thus enabling significant cost-savings for large-scale operations.

Moreover, example solutions are in fact more accurate than state-of-the-art unsupervised named entity recognition techniques, likely due to the fact that the consolidation into representative vectors produces a more generalizable solution that is less prone to overfitting. For instance, in terms of averaged F1 scores, Table 3 below shows a comparison of performance between an example implementations described herein and the “Balie” system by Nadeau, Turney and Matwin for unsupervised named entity recognition with no prior training. Both systems are unsupervised NER systems and both of them are tested on the CONLL-2003 dataset.

TABLE 3
Performance comparison with state-of-the-art unsupervised NER

| Resource | Dataset | F1 Score |
|---|---|---|
| Nadeau, Turney and Matwin | CONLL 2003 | 55.98% |
| Example Implementation | CONLL 2003 | 73.61% |
| Described Herein | | |

Overall, it can be seen that example improvements described herein provide both efficiency and speed, over existing supervised named entity recognition systems and also accuracy gains over existing unsupervised named entity recognition approaches. And, of course, because example solutions set forth herein are unsupervised, they overcome the traditional resource-intensity issues endemic to supervised named entity recognition systems.

FIGS. 3, 4, and 6 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be embodied by software instructions. In this regard, the software instructions which embody the procedures described above may be stored by a memory of an apparatus employing an embodiment of the present invention and executed by a processor of that apparatus. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a computer-readable memory that may direct a computing device or other programmable apparatus to function in a particular manner, such that the software instructions stored in the computer-readable memory produce an article of manufacture, the execution of which implements the functions specified in the flowchart blocks. The software instructions may also be loaded onto a computing device or other programmable apparatus to cause a series of operations to be performed on the computing device or other programmable apparatus to produce a computer-implemented process such that the software instructions executed on the computing device or other programmable apparatus provide operations for implementing the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

In some embodiments, some of the operations above may be modified or further amplified. Furthermore, in some embodiments, additional optional operations may be included. Modifications, amplifications, or additions to the operations above may be performed in any order and in any combination.

### CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for unsupervised named entity recognition, the method comprising:
receiving, by a communications circuitry, a reference named entity list, the reference named entity list including a set of named entities and identifying an entity type of each named entity in the set of named entities;
generating, by a vectorizer, vectors from the named entities included in the reference named entity list;
consolidating, by a synthesizer, the generated vectors into a set of representative vectors, wherein each representative vector is associated with a particular entity type;
receiving, by an analysis engine, a set of text; and
performing, by the analysis engine, named entity recognition on the set of text using the set of representative vectors to generate a tagged set of text.

2. The method of claim 1, wherein generating the vectors from the named entities included in the reference named entity list includes generating a distinct vector from each named entity included in the reference named entity list.

3. The method of claim 1, wherein consolidating the generated vectors into the set of representative vectors includes:
for each particular entity type in the reference named entity list,
generating, by the synthesizer, a subset of the reference named entity list composed of the named entities in the reference named entity list having the particular entity type, and
generating, by the synthesizer, a set of clusters of named entities from the subset of the reference named entity list; and
generating, by the synthesizer, a representative vector for each generated cluster of named entities,
wherein the set of representative vectors comprise the generated representative vectors.

4. The method of claim 3, wherein generating the set of clusters from the subset of the reference named entity list includes:
applying, by the synthesizer, K-means clustering to the subset of the reference named entity list.

5. The method of claim 4, wherein applying K-means clustering to the subset of the reference named entity list includes:
specifying, by the synthesizer, a desired number of clusters;
assigning, by the synthesizer, each named entity in the subset of the reference named entity list to one of the clusters; and
optimizing, by the synthesizer, the cluster assignments.

6. The method of claim 5, wherein optimizing the cluster assignments includes:
(i) calculating, by the synthesizer, a centroid for each cluster based on the named entities assigned to that cluster;
(ii) re-assigning, by the synthesizer, each named entity in the subset of the reference named entity list to the cluster whose centroid is closest in Euclidean distance to the vector generated from the named entity; and
repeating steps (i) and (ii) until cluster assignments stop changing.

7. The method of claim 3, wherein generating the representative vector for the particular cluster of named entities includes:
calculating, by the synthesizer, an element-wise mean of the vectors corresponding to the named entities in the particular cluster of named entities,
wherein the representative vector for the particular cluster of named entities comprises the element-wise mean.

8. The method of claim 1, wherein performing named entity recognition on the set of text using the set of representative vectors to generate the tagged set of text includes:
tokenizing, by the analysis engine, the set of text;
generating, by the vectorizer, token vectors for the tokenized set of text;
identifying, by the analysis engine, entity type tags applicable to the generated token vectors; and
generating, by the analysis engine, the tagged set of text using the tokenized set of text and the identified entity type tags.

9. The method of claim 8, wherein identifying the entity type tags applicable to the generated token vectors includes:
for each generated token vector,
calculating, by the analysis engine, a cosine similarity between the token vector and each representative vector of the set of representative vectors to produce similarity scores for each representative vector;
identifying, by the analysis engine, the representative vector having a highest similarity score;
determining, by the analysis engine, if the similarity score of the identified representative vector exceeds a predefined decision threshold; and
in an instance in which the similarity score of the identified representative vector exceeds the predefined decision threshold, selecting, by the analysis engine, an entity type tag for the token vector corresponding to the entity type associated with the identified representative vector.

10. The method of claim 1, further comprising:
causing, by processing circuitry, application of the tagged set of text in a natural language processing system.

11. An apparatus for unsupervised named entity recognition, the apparatus comprising:
communications circuitry configured to receive a reference named entity list, the reference named entity list including a set of named entities and identifying an entity type of each named entity in the set of named entities;
a vectorizer configured to generate vectors from the named entities included in the reference named entity list;
a synthesizer configured to consolidate the generated vectors into a set of representative vectors, wherein each representative vector is associated with a particular entity type; and
an analysis engine configured to:
receive a set of text; and
perform named entity recognition on the set of text using the set of representative vectors to generate a tagged set of text.

12. The apparatus of claim 11, wherein the vectorizer is configured to generate the vectors from the named entities included in the reference named entity list by generating a distinct vector from each named entity included in the reference named entity list.

13. The apparatus of claim 11, wherein the synthesizer is configured to consolidate the generated vectors into the set of representative vectors by:
for each particular entity type in the reference named entity list,
generating a subset of the reference named entity list composed of the named entities in the reference named entity list having the particular entity type, and
generating a set of clusters of named entities from the subset of the reference named entity list; and
generating a representative vector for each generated cluster of named entities,
wherein the set of representative vectors comprise the generated representative vectors.

14. The apparatus of claim 13, wherein the synthesizer is configured to generate the set of clusters from the subset of the reference named entity list by applying K-means clustering to the subset of the reference named entity list.

15. The apparatus of claim 14, wherein the synthesizer is configured to apply K-means clustering to the subset of the reference named entity list by:
specifying a desired number of clusters;
assigning each named entity in the subset of the reference named entity list to one of the clusters; and
optimizing the cluster assignments.

16. The apparatus of claim 15, wherein the synthesizer is configured to optimize the cluster assignments by:
(i) calculating a centroid for each cluster based on the named entities assigned to that cluster;
(ii) re-assigning each named entity in the subset of the reference named entity list to the cluster whose centroid is closest in Euclidean distance to the vector generated from the named entity; and
repeating steps (i) and (ii) until cluster assignments stop changing.

17. The apparatus of claim 13, wherein the synthesizer is configured to generate the representative vector for the particular cluster of named entities by:
calculating an element-wise mean of the vectors corresponding to the named entities in the particular cluster of named entities,
wherein the representative vector for the particular cluster of named entities comprises the element-wise mean.

18. The apparatus of claim 11, wherein the analysis engine is configured to perform named entity recognition on the set of text using the set of representative vectors to generate the tagged set of text by:
tokenizing the set of text;
causing the vectorizer to generate token vectors for the tokenized set of text;
identifying entity type tags applicable to the generated token vectors; and
generating the tagged set of text using the tokenized set of text and the identified entity type tags.

19. The apparatus of claim 18, wherein the analysis engine is configured to identify the entity type tags applicable to the generated token vectors by:
for each generated token vector,
calculating a cosine similarity between the token vector and each representative vector of the set of representative vectors to produce similarity scores for each representative vector;
identifying the representative vector having a highest similarity score;
determining if the similarity score of the identified representative vector exceeds a predefined decision threshold; and
in an instance in which the similarity score of the identified representative vector exceeds the predefined decision threshold, selecting an entity type tag for the token vector corresponding to the entity type associated with the identified representative vector.

20. A computer program product for unsupervised named entity recognition, the computer program product comprising at least one non-transitory computer-readable storage medium storing software instructions that, when executed, cause an apparatus to:
receive a reference named entity list, the reference named entity list including a set of named entities and identifying an entity type of each named entity in the set of named entities;
generate vectors from the named entities included in the reference named entity list;
consolidate the generated vectors into a set of representative vectors, wherein each representative vector is associated with a particular entity type; and
in response to receiving a set of text, perform named entity recognition on the set of text using the set of representative vectors to generate a tagged set of text.
